(19) United States
(12) Patent Application Publication
(10) Pub. No.: US 2007/0222318 A1
(43) Pub. Date: Sep. 27, 2007

(54) Electromagnetic motor employing multiple rotors

(75) Inventor: Carl L. Godfrey, San Juan Capistrano, CA (US)

Correspondence Address: STETINA BRUNDA GARRED & BRUCKER, 75 ENTERPRISE, SUITE 250, ALISO VIEJO, CA, 92656, US

(73) Assignee: GTS Research, Inc.

(21) Appl. No.: 11/635,430

(22) Filed: Dec. 6, 2006

Related U.S. Application Data
(63) Continuation of application No. 11/132,133, filed on May 18, 2005, now abandoned.
Application No. 11/132,133 is a continuation-in-part of application No. 10/413,761, filed on Apr. 15, 2003, now abandoned.

(51) Int. Cl. H02K 21/12; H02K 15/02

(52) U.S. Cl. 310/156.01; 29/598

(57) ABSTRACT

An electromagnetic motor employing plural rotors is provided, with each rotor exhibiting a permanent magnetic field. A control module selectively induces magnetic fields in electromagnetic pads surrounding each of the rotors. Through the interaction of the permanent and induced magnetic fields, the rotors can turn. As a result, a shaft mechanically engaging the rotors also turns to provide mechanical power. In response to the shaft rotation, an alternator generates electrical power, at least a portion of which can be stored in one or more storage cells. The stored electrical power can be used to sustain the operation of the control module without an external power source. The magnetic polarities of the induced magnetic fields can be reversed, thus causing the rotors to continue turning. In various applications, the motor can be installed in a vehicle or in a building power supply as desired.

### CROSS-REFERENCE TO RELATED APPLICATIONS

This application is a continuation-in-part of, and claims the benefit of, U.S. patent application Ser. No. 10/413,761, filed on Apr. 15, 2003, which is incorporated by reference herein.

### STATEMENT RE: FEDERALLY SPONSORED RESEARCH/DEVELOPMENT

Not Applicable

### BACKGROUND OF THE INVENTION

The present invention relates generally to power generation, and more particularly to the generation of mechanical and electrical power using electromagnetic principles.

As is well known in the art, various methods exist for generating mechanical and electrical power. Such prior methods include combustion, solar power, water power, and others. Unfortunately, these power generation methods exhibit various negative consequences. For example, the internal combustion engine is commonly used to power vehicles and meet the transportation needs of much of the world. However, its widespread use has resulted in pollution and depletion of fossil fuels. Clearly, alternatives to prior art power generation methods are highly desirable.

As is also well known, electromagnets are often employed to operate electric motors, alternators, generators, and other machines. Electromagnets have also been used in industry, as evidenced by the large electromagnets at work in automotive and metal recycling yards.

Through the application of electromagnetic principles, the present invention provides alternative methods and apparatus for generating mechanical and electrical power.

### BRIEF SUMMARY OF THE INVENTION

The present invention, roughly described, provides a motor that operates in accordance with a unique application of electromagnetic principles. The electromagnetic motor of the present invention includes plural rotors, with each rotor exhibiting a permanent magnetic field. A control module is provided which can selectively induce magnetic fields in a plurality of electromagnetic pads encircling the rotors. Interaction between the permanent and induced magnetic fields cause the rotors to turn, thereby rotating a shaft mechanically engaging the rotors. An alternator in mechanical communication with the shaft generates electrical power which sustains the operation of the control module without an external power source.

In various embodiments, the control module is capable of selectively reversing polarities of the induced magnetic fields upon partial turning of the rotors, thereby causing the shaft to continuously rotate. An electromagnetic motor in accordance with the present invention installed in a motor vehicle, providing mechanical power to propel the vehicle and electrical power to charge the vehicle's battery. In another embodiment, the motor can be installed in a building power supply. Storage cells providing electrical power to the motor and/or other apparatus can be recharged by an alternator operating in conjunction with the motor.

These and other embodiments of the present invention are discussed in further detail below.

### BRIEF DESCRIPTION OF THE DRAWINGS

FIG. 1 provides a cross-sectional view of a portion of an electromagnetic motor in accordance with an embodiment of the present invention.

FIG. 2 provides a block diagram of a vehicle utilizing an electromagnetic motor in accordance with an embodiment of the present invention.

FIG. 3 provides a cross-sectional view of multiple rotors of an electromagnetic motor in accordance with an embodiment of the present invention.

FIG. 4 provides a block diagram of a home electrical power supply employing an electromagnetic motor in accordance with an embodiment of the present invention.

FIG. 5 provides a perspective view of a home electrical power supply employing an electromagnetic motor in accordance with an embodiment of the present invention.

FIG. 6 provides a side view of a home electrical power supply employing an electromagnetic motor in accordance with an embodiment of the present invention.

FIG. 7 provides a perspective view of an electromagnetic motor in accordance with an alternate embodiment of the present invention.

FIG. 8 provides a cross-sectional view of a portion of an electromagnetic motor in accordance with an alternate embodiment of the present invention.

FIG. 9 provides an exploded view of an electromagnetic motor in accordance with an alternate embodiment of the present invention.

FIG. 10 provides a block diagram of several components of an electromagnetic motor in accordance with an alternate embodiment of the present invention.

### DETAILED DESCRIPTION OF THE INVENTION

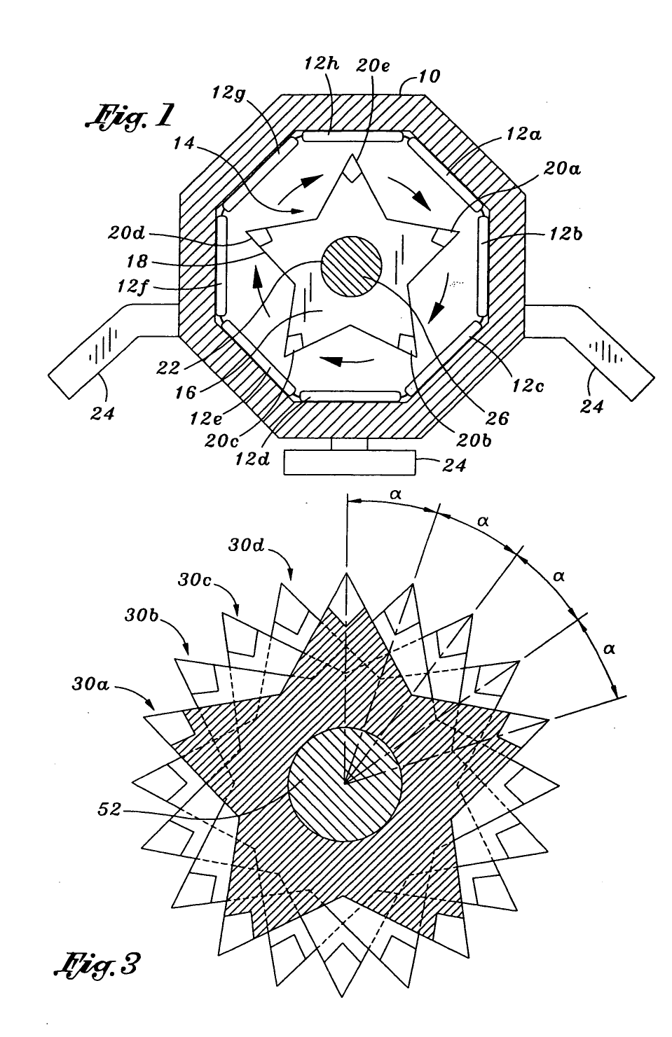

FIG. 1 provides a cross-sectional view of a portion of an electromagnetic motor in accordance with an embodiment of the present invention. The components set forth in FIG. 1 serve to illustrate several of the operational principles of the motor.

Rotor 14 comprises a hub 16, aperture 22, and five coplanar arm members 18 projecting outwardly from the hub 16. Arm members 18 are uniformly distributed around a perimeter of the hub 16 in a star-shaped configuration. In order to dissipate heat, rotor 14 can be made from graphite ceramic composite material. It will be appreciated that, while the structure of rotor 14 bears certain similarities to the Wankel rotary engine, the present invention operates in accordance with electromagnetic principles rather than combustion or compression.

Rotor tips 20a-e are permanent magnetic field sources provided on the distal ends of arm members 18. The rotor tips 20a-e are oriented such that exterior portions of each of the rotor tips 20a-e exhibit the same magnetic polarity projecting outwardly from arm members 18. In one embodiment, these exterior portions exhibit a “north” magnetic polarity. Rotor tips 20a-e can be made from any suitable magnetic material, such as iron-ore (i.e. stainless steel). In the manufacture of rotor 14, each of the rotor tips 20a-e can be inserted into an arm member 18 and then adhered to the arm member 18 with resin or other suitable adhesive.

Shaft 26 is mechanically engaged with rotor 14 through aperture 22. As a result of this engagement, shaft 26 will turn with rotor 14. Shaft 26 can be made from non-ferrous material such as graphite or carbon fiber in order to minimize the effects of magnetic fields on the shaft.

By way of preferred embodiment and not by way of limitation, a plurality and preferably eight electromagnetic pads 12a-h are arranged in a ring configuration encircling rotor 14. As further described herein, magnetic fields of various polarities can be selectively induced in pads 12a-h to turn rotor 14. To facilitate this electromagnetic operation, each of pads 12a-h can be comprised of molded ceramic material with iron composite plates embossed within the face of each pad.

Pads 12a-h and rotor 14 are surrounded by a housing 10. Housing 10 can be made from aluminum in order in order to insulate the interior components from outside magnetic flux. A plurality of mounts 24 are also provided for securing the motor of FIG. 1.

The following example illustrates the operational principles of the present invention by considering the functionality of rotor tips 20a-b in relation to pads 12a-d. As explained above,each of rotor tips 20a-b exhibits a permanent magnetic field with the same magnetic polarity (“first polarity”) directed toward pads 12a-d. As also described above, magnetic fields can be selectively induced in each of pads 12a-d.

Specifically, magnetic fields can be induced in pads 12a and 12c such that surfaces of these pads facing rotor 14 exhibit the same first polarity as rotor tips 20a-b. Similarly, magnetic fields can be induced in pads 12b and 12d such that surfaces of these pads facing rotor 14 exhibit an opposite polarity (“second polarity”).

While these magnetic fields are induced, the interaction between the first and second polarities will cause rotor 14 to turn. Specifically, pads exhibiting the first polarity will repel the rotor tips, and pads exhibiting the second polarity will attract the rotor tips. As a result, rotor tips 20a-b will be repelled from pads 12a and 12c. Meanwhile, rotor tips 20a-b will be attracted toward pads 12b and 12d. This “push-pull” effect of repulsion and attraction between rotor tips 20a-b and pads 12a-d will cause rotor 14 to turn as indicated by the clockwise arrows of FIG. 1. As a result, shaft 26 will also rotate.

After rotor 14 has partially turned in response to these magnetic interactions, rotor tip 20a will be adjacent to pad 12b, and rotor tip 20b will be adjacent to pad 12d. In order to continue the turning of rotor 14 in the clockwise direction, the polarities of the magnetic fields induced in pads 12a-d are reversed. Thus, the polarities of pads 12a and 12c are changed from the first polarity to the second polarity. Similarly, the polarities of pads 12b and 12d are changed from the second polarity to the first polarity. As a result, rotor tip 20a will be repelled from pad 12b and attracted toward pad 12c. Similarly, rotor tip 20b will be repelled from pad 12d.

It will be appreciated that these operational principles can be applied to all rotor tips 20a-e and pads 12a-h of FIG. 1. Thus, magnetic fields of differing polarities can be selectively induced in any of pads 12a-h in order to attract and repel any of the rotor tips 20a-e as desired. For example, magnetic fields of different polarities can be induced in each of the adjacent pads 12a-h, with a first set of pads exhibiting a first polarity (i.e. pads 12a, 12c, 12e, and 12g) and a second set of pads exhibiting a second opposite polarity (i.e. pads 12b, 12d, 12f, and 12h). By selectively inducing magnetic fields in the pads and reversing their polarities, rotor 14 can continue turning in accordance with the principles set forth above. As a result, shaft 26 will also rotate.

It will be appreciated that stronger attraction and repulsion of the rotor tips 20a-e can result from increasing the voltages used to induce the magnetic fields set forth above (for example, the voltages used to induce magnetic fields in pads 12a-h can be increased). It will also be appreciated that, although a clockwise rotation is illustrated in FIG. 1, embodiments employing a counterclockwise rotation are also contemplated.

In one embodiment, a clearance of approximately ⅜ inches is maintained between the rotor tips and pads when no magnetic fields are induced in the pads, and a clearance of approximately ⅛ inches is maintained between rotor tips and pads exhibiting opposite magnetic polarities.

Although FIG. 1 illustrates a single rotor 14, it will be appreciated that an electromagnetic motor in accordance with the present invention preferably employs a plurality of four rotors mechanically engaged with a shaft. Each rotor is encircled by eight electromagnetic pads. The four rotors are offset from each other in the range of approximately 16-18 degrees. Rotors can be added to the shaft in additional sets of four to increase torque on the shaft.

It is estimated that various embodiments of an electromagnetic motor in accordance with the present invention can provide a maximum torque of approximately: 200 ft-lb (using four rotors), 400 ft-lb torque (using eight rotors), and 600 ft-lb torque (using twelve rotors).

In various embodiments, the rotors of an electromagnetic motor in accordance with the present invention run between approximately 24,000 to 32,000 RPM, exhibiting frictional losses of approximately 12-15%. Such frictional losses can be offset by inducing stronger magnetic fields in the electromagnetic pads.

It is contemplated that an electromagnetic motor in accordance with the present invention can be used to supply electrical and/or mechanical power in any appropriate civilian and/or military environment. For example, such an electromagnetic motor can be used in motor vehicles.

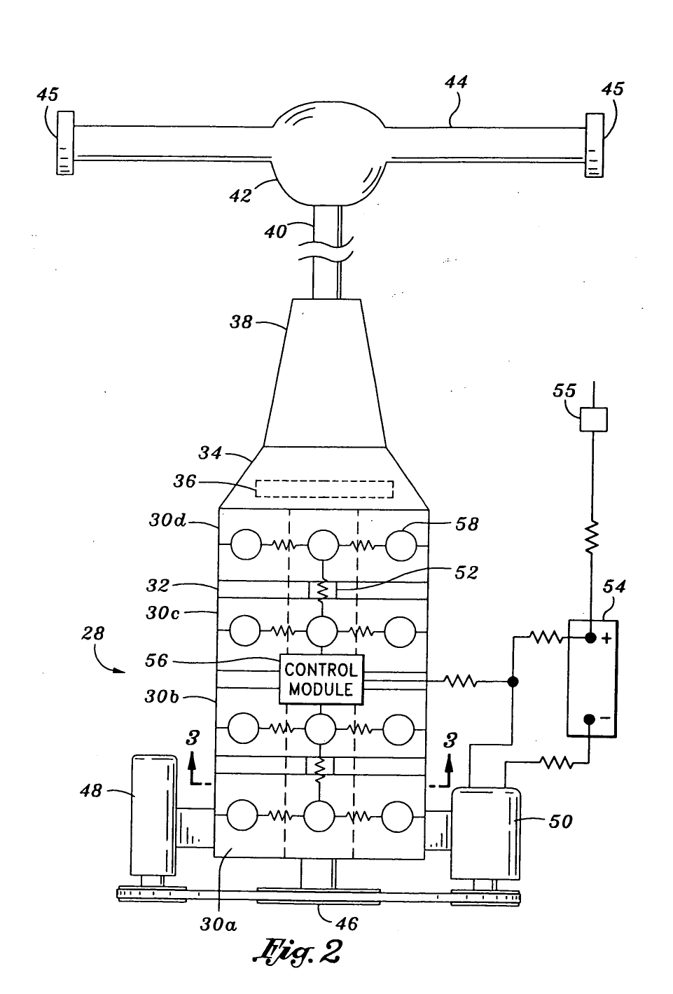

FIG. 2 provides a block diagram of a vehicle utilizing an electromagnetic motor in accordance with an embodiment of the present invention. As illustrated in FIG. 2, the vehicle incorporates many of the traditional components associated with conventional motor vehicles such as: a bellhousing 34, flywheel 36, transmission 38, driveline 40, differential 42, rear drive axle 44, wheels 45, belt pulley 46, and rotary air compressor 48. However, in place of a conventional internal combustion engine, the electromagnetic motor 28 of the present invention is provided.

Motor 28 includes four rotors 30a-d mechanically engaging a shaft 52. Electromagnetic pads 58 are arranged in a plurality of rings, with each ring providing eight pads that encircle one of the rotors 30a-d. Each of the rotors 30a-d can be implemented in the manner illustrated in FIG. 1, with eight pads surrounding each rotor, and the tips of each rotor exhibiting a first permanent magnetic polarity. A housing 32 is also provided for enclosing rotors 30a-d, pads 58, and shaft 52.

Control module 56 is in electrical communication with each of pads 58 for selectively inducing magnetic fields in the pads 58 in accordance with the operational principles described above with regard to FIG. 1. By selectively inducing these magnetic fields, control module 56 can cause rotors 30a-d to turn at a desired RPM.

Shaft 52 is caused to rotate in response to the turning of rotors 30a-d caused by the magnetic fields induced. in pads 52 by control module 56. This rotation of shaft 52 provides mechanical power to transmission 38, driveline 40, and related components illustrated in FIG. 2 in order to propel the vehicle. Appropriate apparatus can be provided to gear down the relatively high RPM of shaft 52 to run driveline 40 at an appropriate lower RPM. Shaft 52 also provides mechanical power to turn belt pulley 46, air compressor 48, and high output alternator 50.

Alternator 50 is turned by belt pulley 46 which is in mechanical communication with shaft 52. Electrical power generated by alternator 50 is provided to control module 56 and battery 54. In one embodiment, battery 54 is a 24 VDC battery.

To start the motor 28, ignition switch 55 causes battery 54 to supply electrical power to control module 56 to initiate the turning of rotors 30a-d. In one embodiment, the battery voltage is converted to a minimum of 10 kV through an ignition coil in order to start the motor 28. After motor 28 has started, electrical power generated by alternator 50 sustains the operation of the control module without an external power source. Alternator 50 also charges battery 54 as necessary.

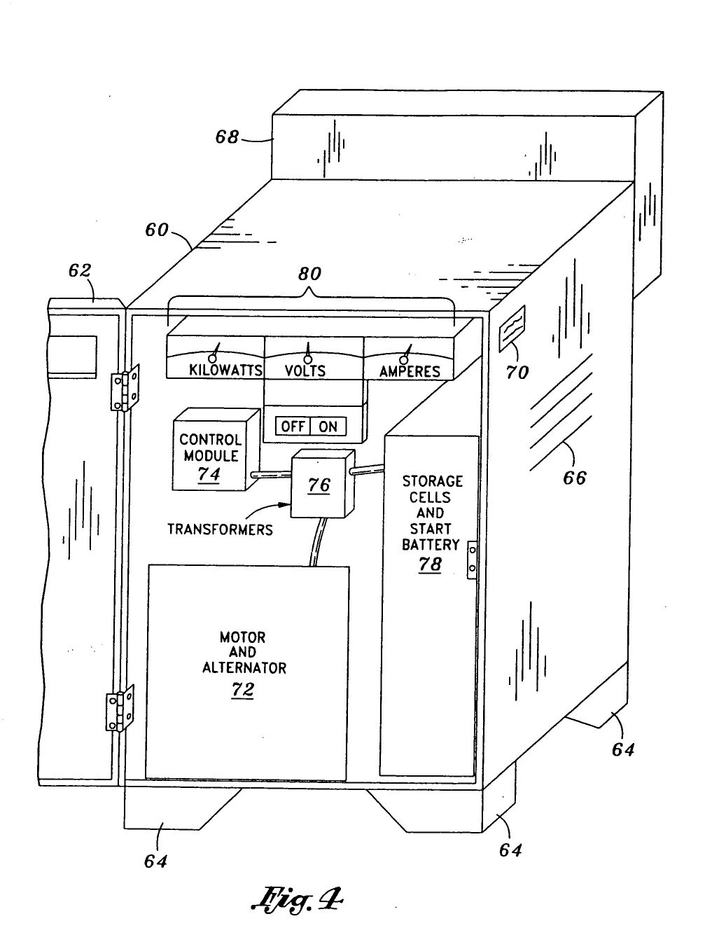

FIG. 3 provides a cross-sectional view of rotors 30a-d taken at line 3-3 of FIG. 2. As illustrated in FIG. 3, each of rotors 30a-d are offset from each other by an angle alpha. In one embodiment, alpha is in the range of approximately 16 to 18 degrees. As a result of this offset, at least one of rotors 30a-d will always be on a “power stroke,” being simultaneously pushed and pulled by magnetic fields induced in pads 58.

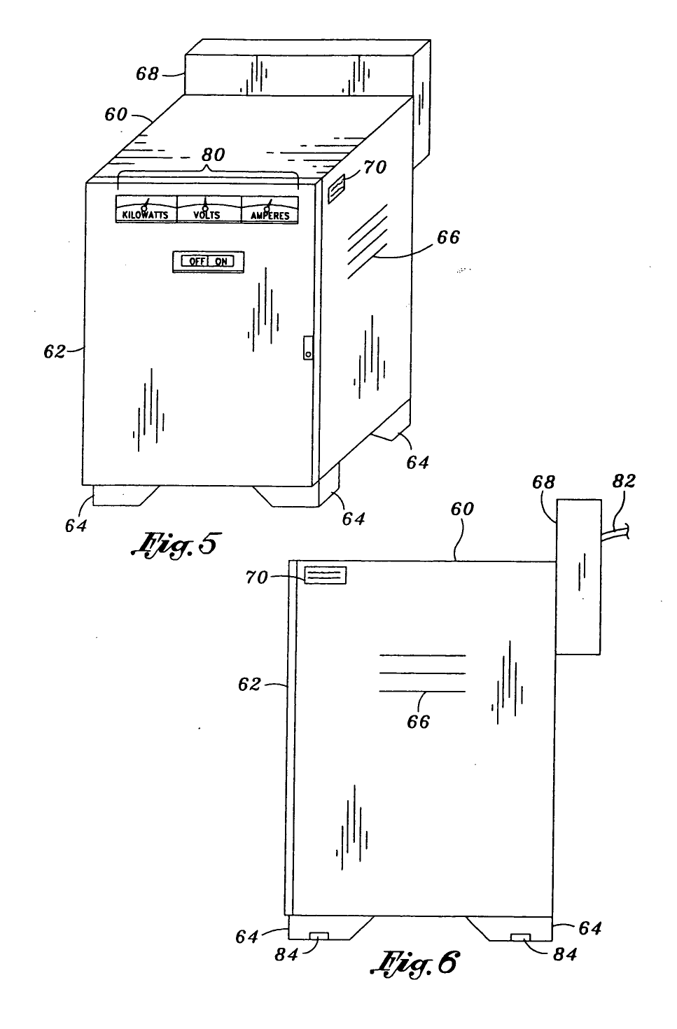

An electromagnetic motor in accordance with the present invention can also be used to supply electrical power to a building or home. FIG. 4 provides a block diagram of a home electrical power supply employing an electromagnetic motor in accordance with an embodiment of the present invention. It is contemplated that the power supply of FIG. 4 can be conveniently installed in the interior of a home, such as a garage.

The power supply of FIG. 4 includes an electromagnetic motor and alternator 72 which employ the operational principles described above. A combination of storage cells and start battery 78 are also provided, and are in electrical communication with control module 74 and motor/alternator 72 through transformer box 76. In one embodiment, cells/battery 78 comprise two primary storage cells and one start battery. The start battery is used to initiate operation of restart motor/alternator 72 when necessary. The storage cells are recharged through the periodic operation of motor/alternator 72. Each storage cell can be implemented with sufficient capacity to supply electrical power to a typical home for approximately ninety days.

A control module 74 is provided for inducing magnetic fields in electromagnetic pads of the motor 72, as previously described herein. Control module 74 is in electrical communication with motor/alternator 72 and cells/battery 78 through transformer box 76. Control module 74 detects when the storage cells are sufficiently drained, and causes the motor/alternator 72 to be restarted using the start battery in order to recharge the storage cells. Control module 74 monitors the charging of cells/battery 78 during the operation of motor/alternator 72. When the cells/battery 78 are fully charged, control module 74 shuts down motor/alternator 72.

Transformer box 76 provides a first transformer for converting the high output voltage of motor/alternator 72 to a low voltage supplied to cells/battery 78. The first transformer can be implemented to convert approximately 880 VAC received from motor/alternator 72 to a lower DC voltage provided to cells/battery 78.

Transformer box 76 further provides a second transformer and a rectifier operating together to convert a low DC voltage from the storage cells to a higher AC voltage to be supplied to a home. The second transformer and rectifier can be implemented to convert DC voltage provided by cells/battery 78 to approximately 220 VAC which is supplied to the home.

As illustrated in FIG. 4, a plurality of gauges 80 are also provided for measuring various aspects of the operation of the power supply as illustrated in FIG. 4. A fuse panel 68 is also provided, permitting convenient user access for troubleshooting purposes.

A housing 60 and door 62 enclose the components described above. In order to dissipate heat from the power supply of FIG. 4, air vents 66 are provided in housing 60. A certification tag 70 is also provided on housing 60 to specify information pertaining to the power supply, such as the model number and certificate. Anchors 64 are used to secure the housing 60 to a floor surface. In one embodiment, the exterior dimensions of the housing 60 are approximately: 48 inches wide, 60 inches tall, and 36 inches deep.

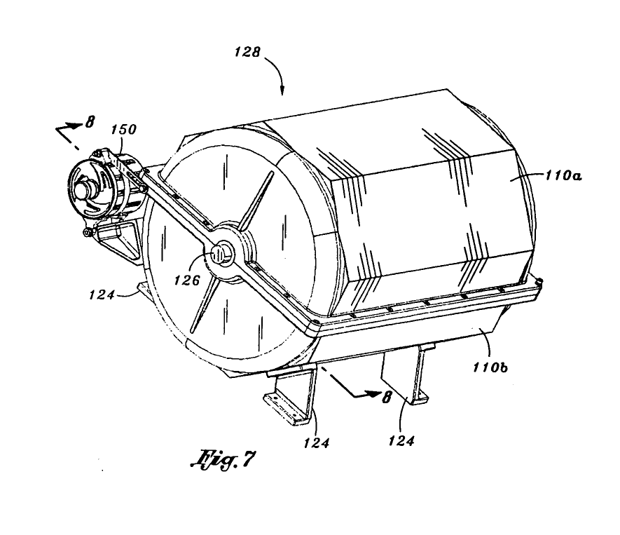

FIGS. 5 and 6 provide perspective and side views, respectively, of the home electrical power supply of FIG. 4. As illustrated in FIG. 6, output wires 82 are provided from fuse panel 68 to provide electrical power supplied by the storage cells through transformer box 76 to a home. As also illustrated in FIG. 6, a plurality of bolts 84 are used to secure the home power supply to a floor surface.

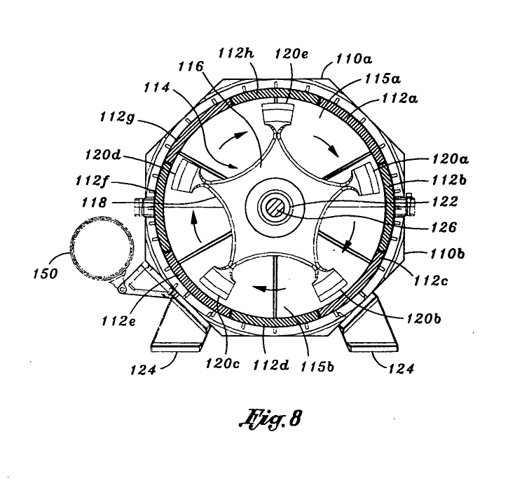

FIG. 7 provides a perspective view of an electromagnetic motor 128 in accordance with an alternate embodiment of the present invention. As illustrated, the motor 128 can be substantially enclosed within a housing comprising top and bottom housings 110a and 110b, respectively. A plurality of mounts 124 are also provided for securing the motor 128.

A shaft 126 of the motor 128 can protrude out of the housings 110a and 110b for connection with apparatus to be turned by the motor 128. In addition, an alternator 150 (for example, a 160 amp alternator) can be provided for generating electrical power as further described herein.

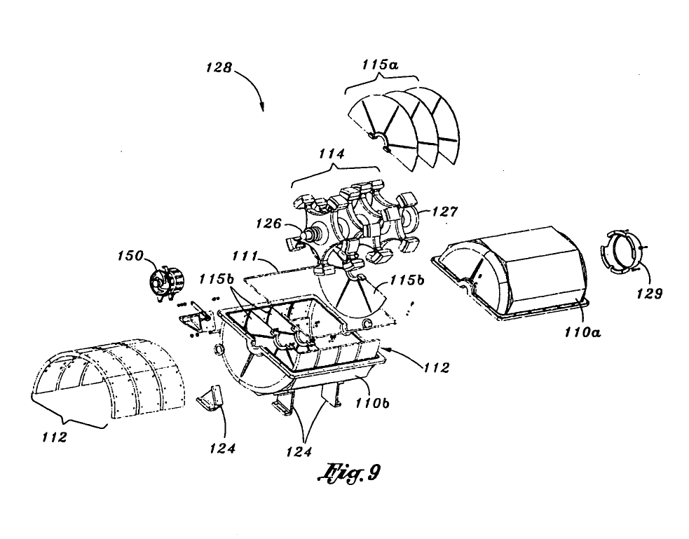

FIG. 8 provides a cross-sectional view of a portion of an electromagnetic motor 128 taken at line 8-8 of FIG. 7. The components set forth in FIG. 8 serve to illustrate several of the operational principles of the motor 128.

Rotor 114 comprises a hub 116, aperture 122, and five coplanar arm members 118 projecting outwardly from the hub 116. Arm members 118 are uniformly distributed around a perimeter of the hub 116 in a star-shaped configuration. In order to dissipate heat, rotor 114 can be made from graphite ceramic composite material. It will be appreciated that, while the structure of rotor 114 bears certain similarities to the Wankel rotary engine, the present invention operates in accordance with electromagnetic principles rather than combustion or compression.

Rotor tips 120a-e are permanent magnetic field sources provided on the distal ends of arm members 118. The rotor tips 120a-e are oriented such that exterior portions of each of the rotor tips 120a-e exhibit the same magnetic polarity projecting outwardly from arm members 118. In one embodiment, these exterior portions exhibit a “north” magnetic polarity. Rotor tips 120a-e can be made from any suitable magnetic material, such as iron-ore (i.e. stainless steel). In the manufacture of rotor 114, each of the rotor tips 120a-e can be inserted into an arm member 118 and then adhered to the arm member 118 with resin or other suitable adhesive.

Shaft 126 is mechanically engaged with rotor 114 through aperture 122. As a result of this engagement, shaft 126 will turn with rotor 114. Shaft 126 can be made from non-ferrous material such as graphite or carbon fiber in order to minimize the effects of magnetic fields on the shaft.

By way of preferred embodiment and not by way of limitation, a plurality and preferably eight electromagnetic pads 112a-h are arranged in a ring configuration encircling rotor 114. As further described herein, magnetic fields of various polarities can be selectively induced in pads 112a-h to turn rotor 114. To facilitate this electromagnetic operation, each of pads 112a-h can be comprised of molded ceramic material with iron composite plates embossed within the face of each pad.

Pads 112a-h and rotor 114 are surrounded by housings 110a and 110b. Housings 110a and 110b can be made from aluminum in order in order to insulate the interior components from outside magnetic flux. A plurality of mounts 124 are also provided for securing the motor 128.

The following example illustrates the operational principles of motor 128 by considering the functionality of rotor tips 120a-b in relation to pads 112a-d. As explained above, each of rotor tips 120a-b exhibits a permanent magnetic field with the same magnetic polarity (“first polarity”) directed toward pads 112a-d. As also described above, magnetic fields can be selectively induced in each of pads 112a-d.

Specifically, magnetic fields can be induced in pads 112a and 112c such that surfaces of these pads facing rotor 114 exhibit the same first polarity as rotor tips 120a-b. Similarly, magnetic fields can be induced in pads 112b and 112d such that surfaces of these pads facing rotor 114 exhibit an opposite polarity (“second polarity”).

While these magnetic fields are induced, the interaction between the first and second polarities will cause rotor 114 to turn. Specifically, pads exhibiting the first polarity will repel the rotor tips, and pads exhibiting the second polarity will attract the rotor tips. As a result, rotor tips 120a-b will be repelled from pads 112a and 112c. Meanwhile, rotor tips 120a-b will be attracted toward pads 112b and 112d. This “push-pull” effect of repulsion and attraction between rotor tips 120a-b and pads 112a-d will cause rotor 114 to turn as indicated by the clockwise arrows of FIG. 8. As a result, shaft 126 will also rotate.

After rotor 114 has partially turned in response to these magnetic interactions, rotor tip 120a will be adjacent to pad 112b, and rotor tip 120b will be adjacent to pad 112d. In order to continue the turning of rotor 114 in the clockwise direction, the polarities of the magnetic fields induced in pads 112a-d are reversed. Thus, the polarities of pads 112a and 112c are changed from the first polarity to the second polarity. Similarly, the polarities of pads 112b and 112d are changed from the second polarity to the first polarity. As a result, rotor tip 120a will be repelled from pad 112b and attracted toward pad 112c. Similarly, rotor tip 120b will be repelled from pad 112d.

It will be appreciated that these operational principles can be applied to all rotor tips 120a-e and pads 112a-h of FIG. 8. Thus, magnetic fields of differing polarities can be selectively induced in any of pads 112a-h in order to attract and repel any of the rotor tips 120a-e as desired. For example, magnetic fields of different polarities can be induced in each of the adjacent pads 112a-h, with a first set of pads exhibiting a first polarity (i.e. pads 112a, 112c, 112e, and 112g) and a second set of pads exhibiting a second opposite polarity (i.e. pads 112b, 112d, 112f, and 112h). By selectively inducing magnetic fields in the pads and reversing their polarities, rotor 114 can continue turning in accordance with the principles set forth above. As a result, shaft 126 will also rotate.

It will be appreciated that stronger attraction and repulsion of the rotor tips 120a-e can result from increasing the voltages used to induce the magnetic fields set forth above (for example, the voltages used to induce magnetic fields in pads 112a-h can be increased). It will also be appreciated that, although a clockwise rotation is illustrated in FIG. 8, embodiments employing a counterclockwise rotation are also contemplated.

Although FIG. 8 illustrates a single rotor 114, it will be appreciated that electromagnetic motor 128 preferably employs a plurality of four rotors 114 mechanically engaged with a shaft 126. Each rotor is encircled by eight electromagnetic pads 112. The four rotors 114 are offset from each other in the range of approximately 16-18 degrees. Rotors 114 can be added to the shaft 126 in additional sets of four to increase torque on the shaft 126.

In order to reduce the effects of electromagnetic fields between adjacent rotors 114 and pads 112, each combination of eight pads 112 and rotor 114 can be compartmentalized from other rotor/pad combinations through the use of upper and lower shrouds 115a and 115b, respectively. Shrouds 115a and 115b can also be implemented to hold bearings of shaft 126 in place. In various embodiments, rotors 114 and/or shrouds 115a and 115b can be constructed of any appropriate materials. In one embodiment, such components are constructed of 661A aluminum. In various embodiments, shaft 126 can provide grounding for rotors 114 and/or shrouds 115a and 115b.

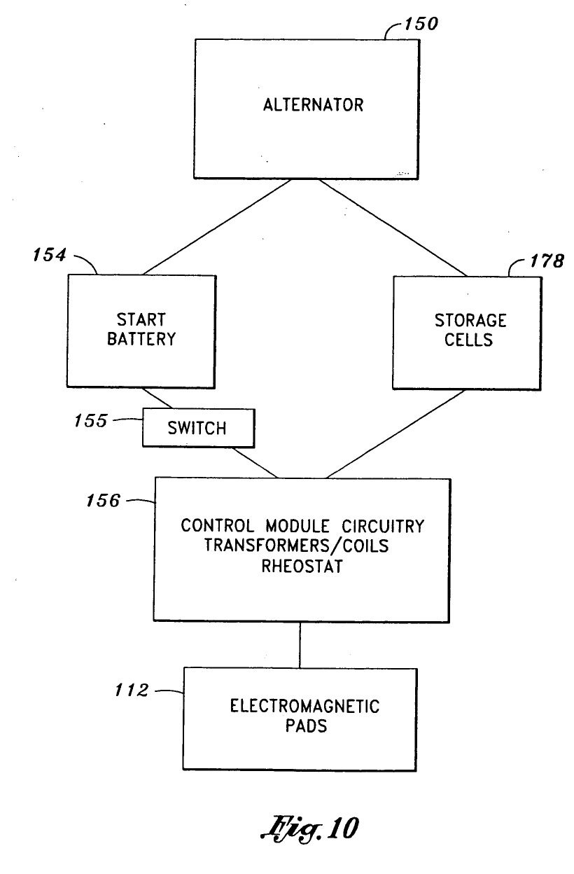

FIG. 9 provides an exploded view of an electromagnetic motor 128 in accordance with an alternate embodiment of the present invention. As illustrated, four rotors 114 are provided engaging shaft 126. As previously discussed in relation to rotors 30a-d of FIG. 3, the rotors 114 of motor 128 can also be offset from each other by an angle alpha. In one embodiment, alpha is in the range of approximately 16 to 18 degrees. As a result of this offset, at least one of the rotors 114 will always be on a “power stroke,” being simultaneously pushed and pulled by magnetic fields induced in pads 112.

Each rotor 114 can be associated with eight electromagnetic pads 112 encircling the rotor. The rotor/pad combinations can be disposed within a plurality of compartments defined by housings 110a and 110b and shrouds 115a and 115b. As illustrated, electromagnetic pads 112 can be secured to housings 110a and 110b. It will be appreciated that the motor 128 illustrated in FIG. 9 provides four such compartments (i.e. one compartment for each rotor/pad combination). As a result, each rotor/pad combination can be effectively shielded from other such combinations, thereby minimizing the effects of electromagnetic fields associated with one rotor/pad combination on other combinations.

Alternator 150 can be configured to be rotated by shaft 126 through mechanical engagement by a belt and pulley system and/or other appropriate mechanisms. As a result, alternator 150 can generate electrical power in response to the rotation of the shaft 126.

A timing apparatus 127 can be provided for adjusting the time at which various electromagnetic fields are induced in pads 112 in relation to the rotation of rotors 114. It will be appreciated that timing apparatus 127 can be implemented in accordance with any appropriate technology. In one embodiment, timing apparatus 127 can be implemented as an electronic visual timing mechanism employing a laser shining on a plurality of grooves (for example 32 grooves) on shaft 126 and/or a suitable timing gear. A housing cap 129 can be connected to housings 110a and 110b for covering and/or shielding the timing apparatus 127. A sealing member 111 disposed between housings 110a and 110b can also be provided for sealing the interface between the housings when motor 128 is assembled.

FIG. 10 provides a block diagram of several components of an electromagnetic motor 128 in accordance with an alternate embodiment of the present invention. As previously described, alternator 150 can be turned as a result of mechanical communication with shaft 126. Electrical power generated by alternator 150 can be provided to control module 156, battery 154 (for example, a 24 volt rechargeable battery), and storage cells 178.

In various embodiments, control module 156 can comprise: appropriate circuitry for switching the polarity of magnetic fields induced in electromagnetic pads 112 (for example, three computer/circuit boards), a plurality of transformers/coils, and one or more rheostats for adjusting the voltage and/or current supplied through the transformers/coils (for example, voltage adjusted in the range of 1 kV to 26 kV) to the electromagnetic pads 112. It will be appreciated that by adjusting the voltage/current supplied through the transformers/coils, the control module 156 can adjust the strength of the magnetic fields induced in electromagnetic pads 112, allowing the rotors 114 of motor 128 to spin faster or slower. In one embodiment a single transformer/coil is employed for each compartmentalized rotor/pad combination. However, it will be appreciated that additional transformers/coils can be employed as desired.

To start the motor 128, ignition switch 155 causes battery 154 to supply electrical power to control module 156 to initiate the turning of rotors 114. The electrical power supplied to the control module 156 can be converted to high voltage (for example, voltage in the range of 1 kv to 26 kV) through one or more appropriate transformers/coils and provided to appropriate electromagnetic pads 112 in order to start the motor 128. After motor 128 has started, electrical power generated by alternator 150 can recharge battery 154 and also be stored in one or more storage cells 178. The electrical power stored in storage cells 178 and/or additional electrical power provided by alternator 150 can be used to sustain the operation of the control module 156, transformers/coils, and electromagnetic pads 112 without an external power source.

It will be appreciated that the scope of the present invention is not limited by the particular embodiments set forth herein. For example, it will be appreciated that any aspects of any one of the electromagnetic motors set forth in this disclosure can be applied to any of the other electromagnetic motors set forth herein, where appropriate. Other appropriate variations, whether explicitly provided for or implied, are contemplated by the present disclosure.

What is claimed is:

1. An electromagnetic motor, comprising:
a plurality of rotors, wherein each of said rotors comprises:
a hub portion,
an aperture in said hub,
a plurality of coplanar arm members projecting outwardly from said hub, and
a permanent magnetic field source in each of said arm members causing a permanent magnetic field to be exhibited from a distal end of each of said arm members;
a plurality of electromagnetic pads arranged in a plurality of rings, wherein each ring encircles one of said rotors;
a shaft mechanically engaging said rotors through said apertures;
a control module in electrical communication with said pads for selectively inducing magnetic fields in said pads, said rotors capable of turning in response to interaction between said permanent magnetic fields and said induced magnetic fields, thereby rotating said shaft;
an alternator in mechanical communication with said shaft for generating electrical power from said rotating of said shaft; and
at least one storage cell for storing at least a portion of the electrical power, wherein said stored electrical power sustains the operation of said control module without an external power source.

2. The electromagnetic motor of claim 1, further comprising:
a housing;
a plurality of shrouds exhibiting electromagnetic shielding; and
a plurality of compartments defined by the housing and shrouds, each rotor and ring disposed within at least one of the compartments.

3. The electromagnetic motor of claim 2, wherein said control module is capable of selectively reversing polarities of said induced magnetic fields upon partial turning of said rotors, thereby causing said shaft to continue rotating.

4. The electromagnetic motor of claim 3, wherein said plurality of rotors comprises four rotors offset approximately 18 degrees from each other.

5. The electromagnetic motor of claim 3, wherein said arm members are uniformly distributed around a perimeter of said hub portion.

6. The electromagnetic motor of claim 5, wherein said plurality of arm members comprises five arm members.

7. The electromagnetic motor of claim 3, wherein each of said rings comprises eight electromagnetic pads.

8. The electromagnetic motor of claim 3, wherein:
said motor is installed in a motor vehicle,
said rotating of said shaft provides mechanical power to propel said vehicle, and
said electrical power provided by said alternator further charges a start battery of said vehicle.

9. The electromagnetic motor of claim 3, wherein:
said motor is installed in a building power supply, and
said electrical power provided by said alternator further charges a plurality of storage cells for supplying said electrical power to said building.

10. A method for generating power, comprising:
providing a plurality of rotors, each of said rotors exhibiting a permanent magnetic field;
providing a shaft mechanically engaging said rotors;
providing a plurality of electromagnetic pads arranged in a plurality of rings, wherein each ring encircles one of said rotors;
inducing a first plurality of magnetic fields in a first set of said pads, wherein said first pads exhibit a first magnetic polarity toward said rotors;
inducing a second plurality of magnetic fields in a second set of said pads, wherein said second pads exhibit a second magnetic polarity toward said rotors;
permitting said rotors to turn in response to interaction between said permanent and induced magnetic fields, thereby rotating said shaft;
generating electrical power in response to said rotation of said shaft; and
storing at least a portion of the electrical power in a storage cell, wherein said stored electrical power is sufficient to perform said inducing steps without an external power source.

11. The method of claim 10, further comprising:
providing a housing;
providing a plurality of shrouds exhibiting electromagnetic shielding; and
providing a plurality of compartments defined by the housing and shrouds, each rotor and ring disposed within at least one of the compartments.

12. The method of claim 11, wherein each of said rotors comprises:
a hub portion;
aperture in said hub;
a plurality of coplanar arm members projecting outwardly from said hub; and
a permanent magnetic field source in each of said arm members causing said permanent magnetic field of each of said rotors, wherein distal ends of each of said arm members exhibit said first magnetic polarity.

13. The method of claim 12, wherein said interaction comprises:
repelling a first set of said arm members from said pads exhibiting said first magnetic polarity, thereby causing said rotors to turn away from said first pads; and
attracting a second set of said arm members to said pads exhibiting said second magnetic polarity, thereby causing said rotors to turn toward said second pads.

14. The method of claim 13, further comprising:
reversing said induced magnetic fields after said rotors have partially turned, wherein said first pads exhibit said second magnetic polarity toward said rotors, and said second pads exhibit said first magnetic polarity toward said rotors; and
permitting said rotors to continue turning in response to interaction between said permanent and induced magnetic fields, thereby causing said shaft to continue rotating.

15. The method of claim 14, wherein said plurality of rotors comprises four rotors offset approximately 18 degrees from each other.

16. The method of claim 14, wherein said arm members are uniformly distributed around a perimeter of said hub portion.

17. The method of claim 14, wherein said plurality of arm members comprises five arm members.

18. The method of claim 14, wherein each of said rings comprises eight electromagnetic pads.

19. The method of claim 14, wherein:
said rotation of said shaft provides mechanical power to propel a vehicle, and
said electrical power further charges a start battery of said vehicle.

20. The method of claim 14, wherein said electrical power further charges a plurality of storage cells for supplying said electrical power to a building.
